(19) United States
(12) Patent Application Publication
(10) Pub. No.: US 2013/0234966 A1
(43) Pub. Date: Sep. 12, 2013

(54) OPTICAL ELEMENT AND DISPLAY SYSTEM

(71) Applicant: INNOLUX CORPORATION, Chu Nan (TW)

(72) Inventor: Min-Chao JHUANG, Chu-Nan (TW)

(73) Assignee: INNOLUX CORPORATION, Chu-Nan (TW)

(21) Appl. No.: 13/791,693

(22) Filed: Mar. 8, 2013

(30) Foreign Application Priority Data
Mar. 12, 2012 (TW) 101108242

(51) Int. Cl. G02B 27/28; G06F 3/041

(52) U.S. Cl. CPC G02B 27/286; G06F 3/041
USPC 345/173; 359/489.06

(57) ABSTRACT

According to an embodiment of the invention, an optical element is provided. The optical element includes: a substrate having a birefringence characteristic and having a first surface and a second surface; a first transflective optical film disposed on the first surface of the substrate; and a second transflective optical film disposed on the second surface of the substrate. According to an embodiment of the invention, a display system including the optical element is also provided.

### CROSS REFERENCE TO RELATED APPLICATIONS

This application claims priority of Taiwan Patent Application No. 101108242, filed on Mar. 12, 2012, the entirety of which is incorporated by reference herein.

### BACKGROUND

1. Field

The invention relates to an optical element and a display system, and in particular relates to a display system including a touch panel and a display panel.

2. Description of the Related Art

The projected capacitive technology has been widely applied in the touch panel technology. The projected capacitive touch panel may include a glass-type touch panel or a film-type touch panel.

Typically, a touch panel operates with a display panel. A commonly used display panel may be a liquid crystal display panel. Making the touch panel and the display panel fit the desire of the users, have become an important issue.

FIG. 1 is a perspective view showing a conventional display system. As shown in FIG. 1, a display system 100 includes a display panel 102, a touch panel 104, and a backlight source 106. In FIG. 1, the touch panel 104 is, for example, a film-type touch panel which includes, for example, a polyethylene terephthalate (PET) substrate having a birefringence characteristic. The display panel 102 is, for example, a liquid crystal display panel which may includes a polarization layer 102P1, a polarization layer 102P2, and a liquid crystal unit 102C sandwiched therebetween. The inventor of this application found that if the film-type touch panel 104 operates together with the display panel 102, light coming from the light exit surface is not a linearly polarized light but an elliptically polarized light. In this case, if a user who wears polarized sunglasses watches the display system 100, a mura phenomenon is observed, which negatively affects the display quality.

In the following, the mechanism which may result in the mura phenomenon is illustrated in accompany with FIG. 1. As shown in FIG. 1, the non-polarized light L emitted from the backlight source 106 becomes a linearly polarized light after penetrating the polarization layer 102P 1 of the display panel 102. When the liquid crystal panel is in the bright state, the linearly polarized light which rotates by an angle after penetrating the liquid crystal unit 102C may penetrate through the polarization layer 102P2 and continue to enter the touch panel 104. However, in FIG. 1, the touch panel 104 is a film-type touch panel which includes, for example, a PET substrate having a birefringence characteristic. When the linearly polarized light passes the PET substrate having a birefringence characteristic, two components of the linearly polarized light encounter different retardations such that the linearly polarized light becomes an elliptically polarized light. Because light having different wavelengths (i.e., light with different colors) encounter different elliptical polarization degrees, the amount of light with different colors penetrating through the polarized sunglasses are also different if an observer who wears the polarized sunglasses observes the display system 100.

As shown in FIG. 1, the elliptically polarized light with different colors encounter different elliptical polarization degrees after passing through the touch panel 104. Thus, after the elliptically polarized light with different colors penetrate through a polarization layer 108 (simulating the polarized sunglasses), they are transformed into linearly polarized light having different intensities, thus resulting in the mura phenomenon.

Besides the situations mentioned above, if an anti-reflection film or an anti-scattering film is disposed in the display system, the mura phenomenon may also occur similarly.

### SUMMARY

According to an embodiment of the invention, an optical element is provided. The optical element includes: a substrate having a birefringence characteristic and having a first surface and a second surface; a first transflective optical film disposed on the first surface of the substrate; and a second transflective optical film disposed on the second surface of the substrate.

According to an embodiment of the invention, a display system is provided. The display system includes: a display panel; and a touch panel disposed on the display panel, wherein the touch panel includes: a substrate having a birefringence characteristic and having a first surface and a second surface; a first transflective optical film disposed on the first surface of the substrate; and a second transflective optical film disposed on the second surface of the substrate.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a perspective view showing a conventional display system;

FIG. 2 is a cross-sectional view showing an optical element according to an embodiment of the present invention;

FIGS. 3A-3B are cross-sectional views respectively showing optical elements according to embodiments of the present invention; and

FIGS. 4A-4C are three-dimensional views respectively showing display systems according to embodiments of the present invention.

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

The manufacturing method and method for use of the embodiment of the invention are illustrated in detail as follows. It is understood, that the following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numbers and/or letters in the various examples. This repetition is for the purpose of simplicity and clarity and does not in itself dictate a relationship between the various embodiments and/or configurations discussed. Furthermore, descriptions of a first layer “on,” “overlying,” (and like descriptions) a second layer, include embodiments where the first and second layers are in direct contact and those where one or more layers are interposing the first and second layers.

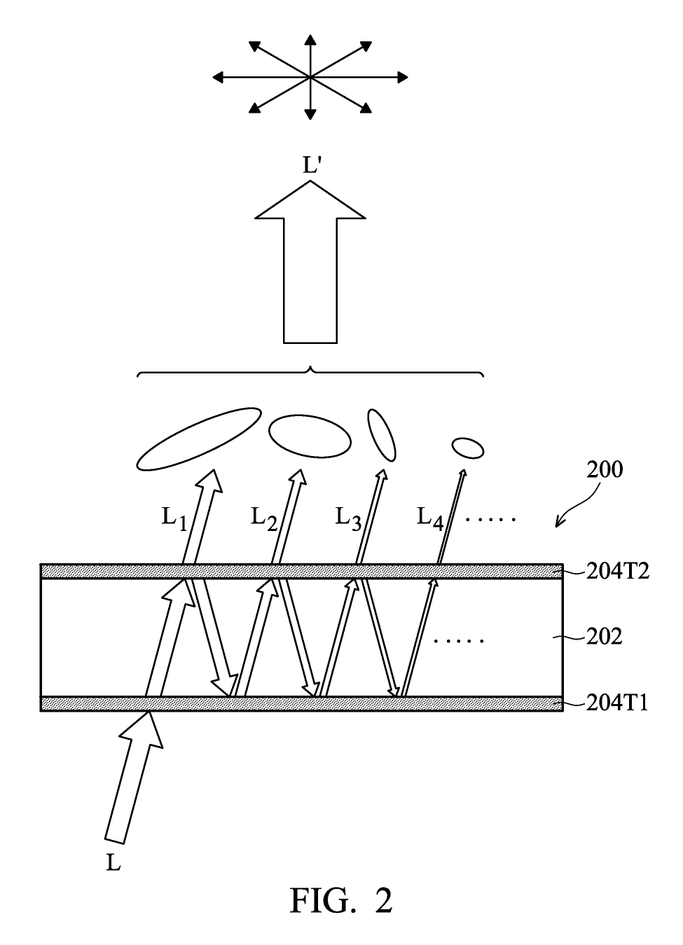

In order to reduce and/or resolve the mura problem mentioned above, the inventor of the application provides an optical element. FIG. 2 is a cross-sectional view showing an optical element 200 according to an embodiment of the present invention. The optical element 200 may be used to transform an elliptically polarized light into a non-polarized light or a substantially not polarized light.

As shown in FIG. 2, the optical element 200 includes a substrate 202 and an optical film 204T1 and an optical film 204T2 disposed on two sides of the substrate 202. In one embodiment, the substrate 202 is a substrate having a birefringence characteristic, which is, for example, a polymer substrate. In one embodiment, the substrate 202 is a PET (polyethylene terephthalate) substrate, a PEN (polyethylene naphthalate) substrate, a PI (polyimide) substrate, or combinations thereof. In one embodiment, the optical films 204T1 and 204T2 directly contact with the two sides of the substrate 202, respectively. The optical films 204T1 and 204T2 may be transflective layers which allow a portion of light to penetrate therethrough and let another portion of light be reflected.

As shown in FIG. 2, when the linearly polarized light L enters the optical element 200, the linearly polarized light L may penetrate through the optical film 204T1 to enter the substrate 202. In one embodiment, because the substrate 202 has a birefringence characteristic, the linearly polarized light L is transformed into an elliptically polarized light. Because there are optical films 204T1 and 204T2 disposed on two sides of the substrate 202, portions of the elliptically polarized light undergo a plurality of reflections or transmissions between the two optical films 204T1 and 204T2. The phases of these portions of the elliptically polarized light change during each of the reflections. Thus, the elliptically polarized light finally transmitted from the optical element 200 has a variety of different phases. For example, although light L1 and lights L2, L3, or L4 may still be elliptically polarized light, the phases thereof are different from each other. These elliptically polarized light having different phases together form a non-polarized light (or substantially not polarized light) L′.

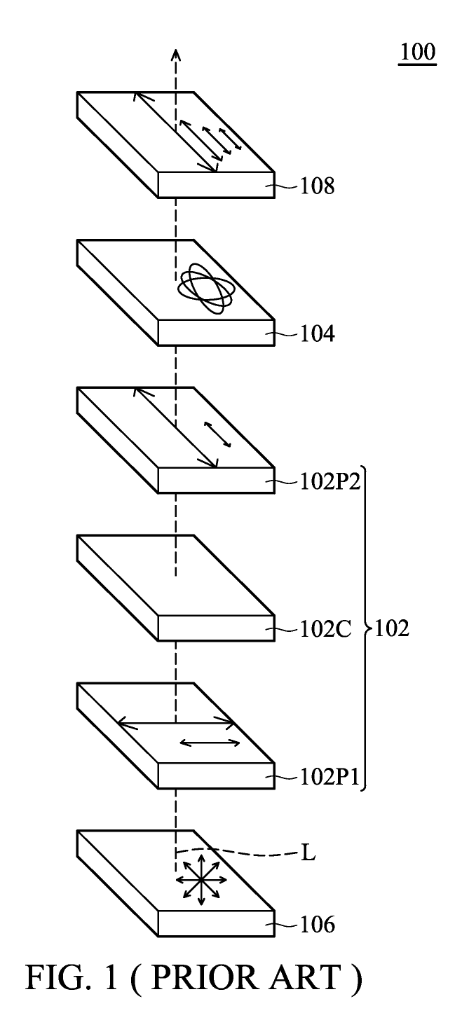

In one embodiment, the optical element 200 illustrated in the embodiment shown in FIG. 2 may be integrated with the display system illustrated in FIG. 1. The optical element 200 may be used to, for example, turn the elliptically polarized light into the non-polarized light. After the non-polarized light passes through a polarization layer or a polarized sunglasses, the non-polarized light becomes a linearly polarized light having a variety of colored lights with substantially the same intensity. There is substantially no problem due to the mura phenomenon.

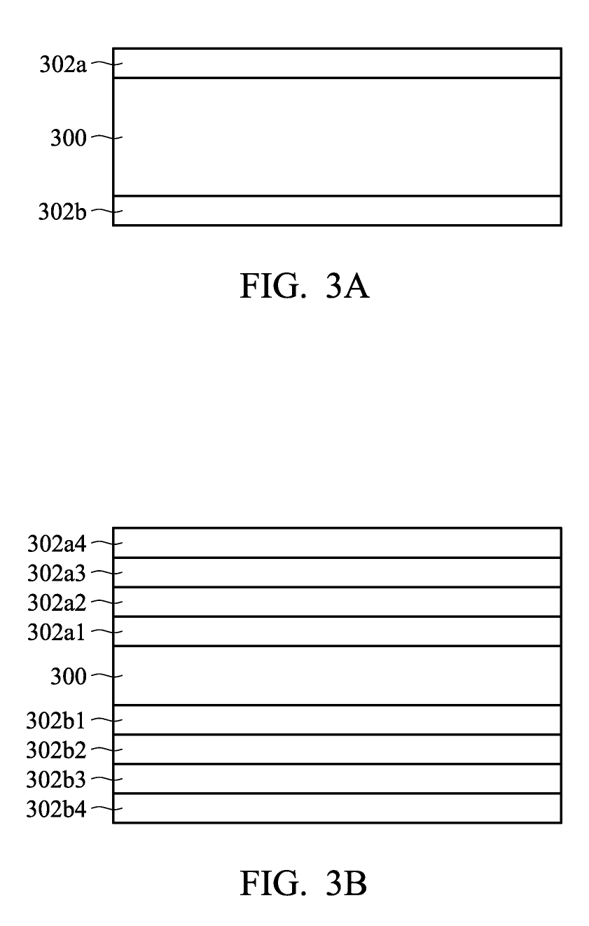

FIGS. 3A-3B are cross-sectional views respectively showing optical elements according to embodiments of the present invention. As shown in FIG. 3A, in one embodiment, the optical element may include a substrate 300 and transflective optical films 302a and 302b disposed on two sides of the substrate 300. The substrate 300 may be a substrate having a birefringence characteristic. The transflective optical films 302a and 302b may be transflective layers such as aluminum films, silver films, copper film, gold films, platinum film, chromium films, nickel films, or combination thereof. In one embodiment, the material of the transflective optical films 302a and the material of the transflective optical films 302b are the same. In another embodiment, the material of the transflective optical films 302a is different from the material of transflective optical films 302b. In one embodiment, the visible transmittance of the transflective optical film 302a or 302b is larger than the visible reflectance of the transflective optical film 302a or 302b. For example, the visible transmittance of the transflective optical film 302a or 302b may be about 60%, and the reflectance thereof may be about 40%. In a preferable embodiment, the visible reflectance of the transflective optical film 302a or 302b is larger than the visible transmittance of the transflective optical film 302a or 302b. For example, the visible transmittance of the transflective optical film 302a or 302b may be about 30%, and the reflectance thereof may be about 70%. It should be appreciated that the visible reflectance of the transflective optical film 302a or 302b ranging from 40%-70% is sufficient for reducing the problem due to the mura phenomenon. In one embodiment, the substrate 300 may be (but is not limited to) a PET substrate with a thickness of about 180 μm, and both the transflective optical films 302a and 302b are (but is not limited to) aluminum films with a thickness of about 3 nm.

In another embodiment, the transflective optical film may be a stacked structure of a plurality of material layers. As shown in FIG. 3B, transflective optical films disposed on the two sides of the substrate 300 may be stacked layers of transflective optical films 302a1, 302a2, 302a3, and 302a4 and stacked layers of transflective optical films 302b1, 302b2, 302b3, and 302b4, respectively. In one embodiment, these stacked layers of the transflective optical films are stacked layers having transflective optical films with higher refractive indices and transflective optical films with smaller refractive indices disposed alternately. For example, the refractive index of the transflective optical film 302a1 may be larger than the refractive index of the transflective optical film 302a2. The refractive index of the transflective optical film 302a2 may be smaller than the refractive index of the transflective optical film 302a3. In one embodiment, the substrate 300 may be (but is not limited to) a PET substrate with a thickness of about 180 μm, and both the transflective optical films disposed on the two sides of the substrate 300 may be stacked layers of a Nb₂O₅ film with a thickness of about 91 nm, a SiO₂ film with a thickness of about 78 nm, and a Nb₂O₅ film with a thickness of about 45 nm. In one embodiment, a suitable transflective optical film with a higher refractive index may include a TiO₂ film, a Nb₂O₅ film, a Ta₂O₅ film, a SnO₂ film, or combinations thereof, and a suitable transflective optical film with a smaller refractive index may include a SiO₂ film, a MgF₂ film, a Na₃AlF₆ film, or combinations thereof.

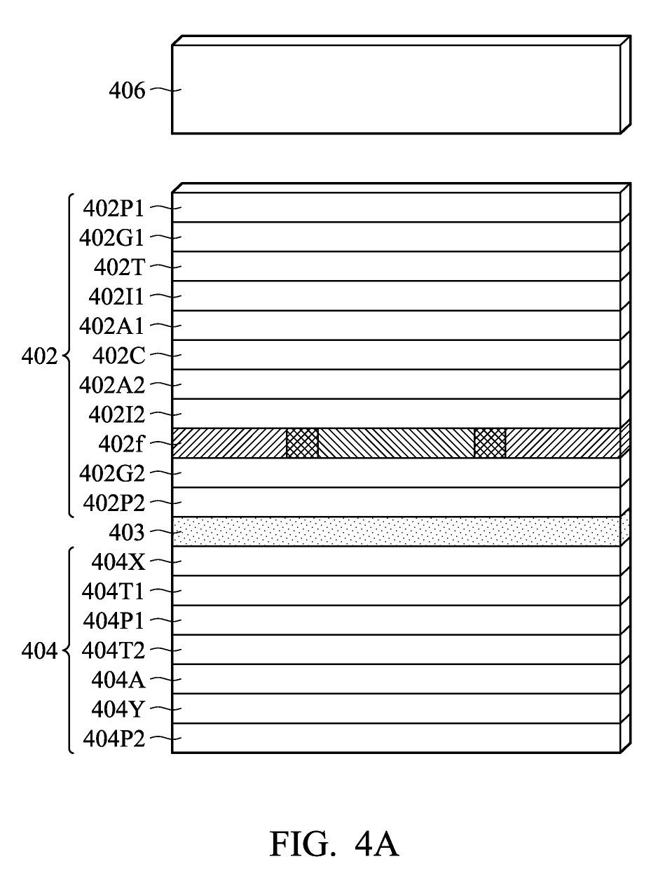

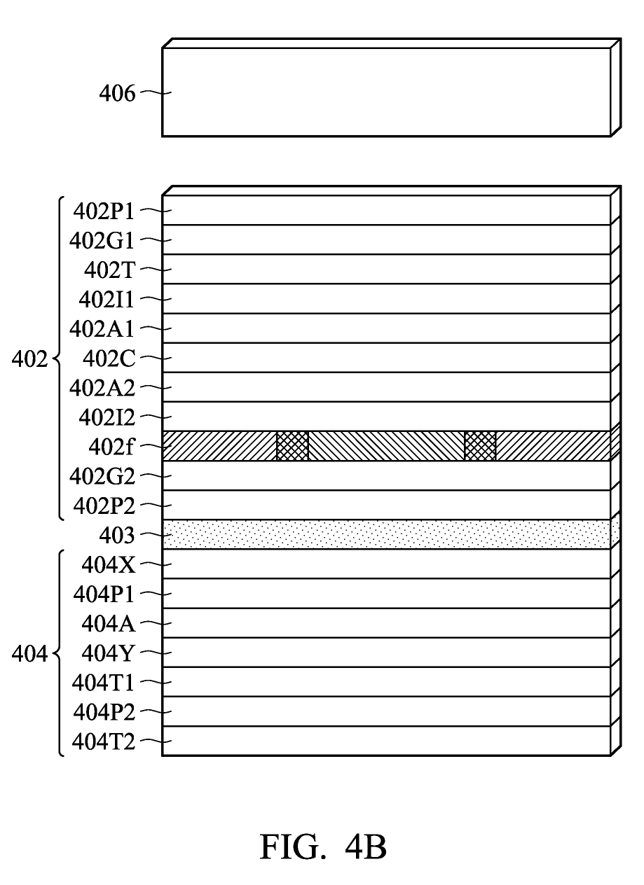

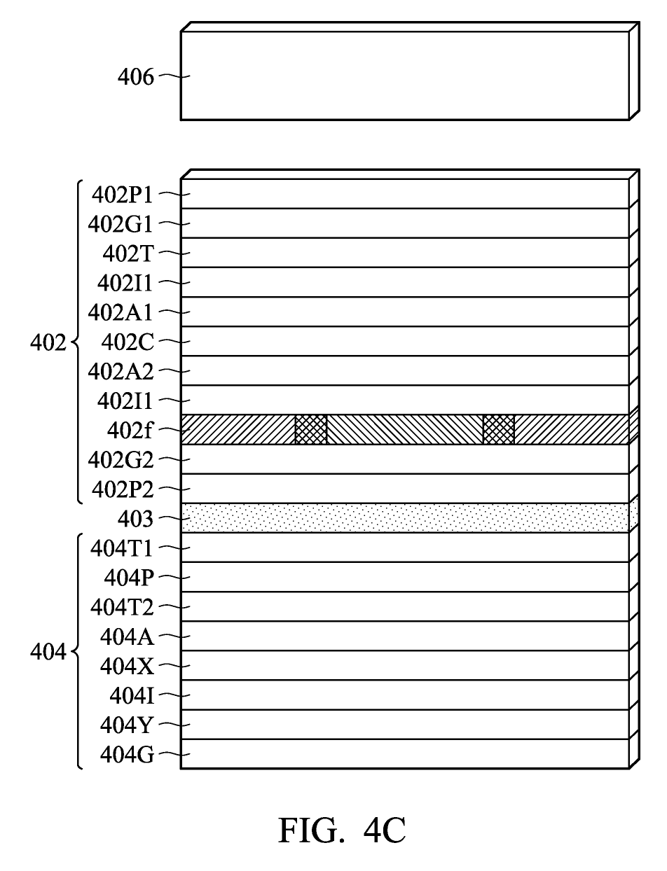

FIGS. 4A-4C are three-dimensional views respectively showing display systems according to embodiments of the present invention, which illustrate that an optical element is introduced into a display system composed of a liquid crystal display panel and a touch panel for reducing and/or preventing the problem due to the mora phenomenon.

As shown in FIG. 4A, the display system includes a backlight source 406, a display panel 402, a touch panel 404, and an adhesion layer or air gap 403 therebetween. In one embodiment, the display panel 402 may include a stacked structure of a polarization layer 402P1, a glass substrate 402G1, a thin film transistor array 402T, an ITO layer 402I1, an alignment layer 402A1, a liquid crystal unit 402C, an alignment layer 402A2, an ITO layer 402I2, a color filter layer array 402f, a glass substrate 402G2, and a polarization layer 402P2. In one embodiment, the touch panel 404 may include an electrode layer 404X, a transflective optical film 404T1, a plastic substrate 404P1 (which may have a birefringence characteristic), a transflective optical film 404T2, an adhesion layer 404A, an electrode layer 404Y, and a plastic substrate 404P2, wherein an optical element composed of the transflective optical film 404T1, the plastic substrate 404P1 (which may have a birefringence characteristic), and the transflective optical film 404T2 may transform an elliptically polarized light into a non-polarized light.

As shown in FIG. 4A, after the non-polarized light coming from the backlight source 406 passes the display panel 402 to be transformed into a linearly polarized light and then passes through the optical element composed of the transflective optical film 404T1, the plastic substrate 404P1, and the transflective optical film 404T2, it is transformed into a non-polarized light. Thus, even if the non-polarized light passes through the plastic substrate 404P2, it is still a non-polarized light. Even if a user wearing polarized sunglasses or an anti-reflection layer or anti-spreading film is additionally disposed on the display system, the problem due to the mora phenomenon is substantially not encountered.

In another embodiment, as shown in FIG. 4B, the display system includes a backlight source 406, a display panel 402, a touch panel 404, and an adhesion layer or air gap 403 therebetween. The display panel 402 may be substantially the same with the display panel 402 shown in FIG. 4A. The touch panel 404 may include a stacked structure of an electrode layer 404X, a plastic substrate 404P1, an adhesion layer 404A, an electrode layer 404Y, a transflective optical film 404T1, a plastic substrate 404P2, and a transflective optical film 404T2.

In this case, a non-polarized light coming from the backlight source 406 is transformed into a linearly polarized light after passing through the display panel 402, which is then transformed into an elliptically polarized light after passing through the plastic substrate 404P 1 having a birefringence characteristic. Even so, the elliptically polarized light may be transformed into a non-polarized light after passing through the optical element composed of the transflective optical film 404T1, the plastic substrate 404P2, and the transflective optical film 404T2. Thus, even if a user wearing polarized sunglasses or an anti-reflection layer or anti-spreading film is additionally disposed on the display system, the problem due to the mura phenomenon is substantially not encountered.

In yet another embodiment, as shown in FIG. 4C, the display system includes a backlight source 406, a display panel 402, a touch panel 404, and an adhesion layer or air gap 403 therebetween. The display panel 402 may be substantially the same with the display panel 402 shown in FIG. 4A. The touch panel 404 may include a stacked structure of a transflective optical film 404T1, a plastic substrate 404P, a transflective optical film 404T2, an adhesion layer 404A, an electrode layer 404X, an insulating layer 404I, an electrode layer 404Y, and a glass substrate 404G.

In this case, the linearly polarized light penetrating the display panel 402 may be transformed into a non-polarized light after passing through the optical element composed of the transflective optical film 404T1, the plastic substrate 404P (which is, for example, an anti-spreading film), and the transflective optical film 404T2. Thus, even if a user wearing polarized sunglasses or an anti-reflection layer is additionally disposed on the display system, the problem due to the mura phenomenon is substantially not encountered.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An optical element, comprising:
a substrate having a birefringence characteristic and having a first surface and a second surface;
a first transflective optical film disposed on the first surface of the substrate; and
a second transflective optical film disposed on the second surface of the substrate.

2. The optical element as claimed in claim 1, wherein the first transflective optical film and the second transflective optical film directly contact with the substrate.

3. The optical element as claimed in claim 1, wherein the first transflective optical film or the second transflective optical film comprises an aluminum film, a silver film, a copper film, a gold film, a platinum film, a chromium film, a nickel film, or combinations thereof.

4. The optical element as claimed in claim 1, wherein the visible reflectance of the first transflective optical film or the second transflective optical film ranges from 40%-70%.

5. The optical element as claimed in claim 1, wherein the visible reflectance of the first transflective optical film or the second transflective optical film is larger than the visible transmittance of the first transflective optical film or the second transflective optical film.

6. The optical element as claimed in claim 1, wherein the first transflective optical film or the second transflective optical film comprises a stacked structure of a plurality of material layers.

7. The optical element as claimed in claim 6, wherein the refractive index of a first material layer in the stacked structure of the material layers is larger than the refractive index of a neighboring second material layer in the stacked structure of the material layers, and the refractive index of the second material layer is smaller than the refractive index of a neighboring third material layer in the stacked structure of the material layers.

8. The optical element as claimed in claim 7, wherein the material of the second material layer comprises SiO₂, MgF₂, Na₃AlF₆, or combinations thereof.

9. The optical element as claimed in claim 7, wherein the material of the first material layer or the third material layer comprises TiO₂, Nb₂O₅, Ta₂O₅, SnO₂, or combinations thereof.

10. The optical element as claimed in claim 1, wherein the material of the substrate comprises polyethylene terephthalate, polyethylene naphthalate, polyimide or combinations thereof.

11. A display system, comprising:
a display panel; and
a touch panel disposed on the display panel, wherein the touch panel comprises:
a substrate having a birefringence characteristic and having a first surface and a second surface;
a first transflective optical film disposed on the first surface of the substrate; and
a second transflective optical film disposed on the second surface of the substrate.

12. The display system as claimed in claim 11, wherein the touch panel comprises a first electrode layer and a second electrode layer.

13. The display system as claimed in claim 12, wherein the substrate, the first transflective optical film, and the second transflective optical film are located between the first electrode layer and the second electrode layer.

14. The display system as claimed in claim 12, wherein the substrate, the first transflective optical film, and the second transflective optical film are located between the display panel and the first and the second electrode layers.

15. The display system as claimed in claim 12, wherein the first electrode layer and the second electrode layer are located between the display panel and the substrate, the first transflective optical film, and the second transflective optical film.

16. The display system as claimed in claim 11, wherein the first transflective optical film and the second transflective optical film directly contact with the substrate.

17. The display system as claimed in claim 11, wherein the visible reflectance of the first transflective optical film or the second transflective optical film ranges from 40%-70%.

18. The display system as claimed in claim 11, wherein the visible reflectance of the first transflective optical film or the second transflective optical film is larger than the visible transmittance of the first transflective optical film or the second transflective optical film.
